(19) United States
(12) Patent Application Publication
(10) Pub. No.: US 2025/0079042 A1
(43) Pub. Date: Mar. 6, 2025

(54) Method of Manufacturing a Dynamic Submarine Power Cable with High Friction Layer

(71) Applicant: NKT HV Cables AB, Lyckeby (SE)

(72) Inventors: Henrik Torvaldsson, Karlskrona (SE); Andreas Tyrberg, Lyckeby (SE)

(21) Appl. No.: 18/818,058

(22) Filed: Aug. 28, 2024

(30) Foreign Application Priority Data
Sep. 4, 2023 (EP) 23195191.4

(51) Int. Cl. H01B 7/14; H01B 3/44; H01B 7/282; H01B 19/04

(52) U.S. Cl. CPC H01B 7/14; H01B 3/441; H01B 7/282; H01B 19/04

(57) ABSTRACT

A method of manufacturing a dynamic submarine power cable, the method including: a) providing an insulation system around a conductor, the insulation system including an inner semiconducting layer, an insulation layer arranged around the inner semiconducting layer, and an outer semiconducting layer arranged around the insulation layer, b) providing a semiconducting polymeric layer around the outer semiconducting layer, c) providing a longitudinally welded metallic radial water blocking layer around the polymeric layer, the metallic radial water blocking layer being in contact with the polymeric layer, and d) heating the metallic radial water blocking layer after step c) such that the polymeric layer melts and forms an adhesive layer that adheres to an inner surface of the metallic radial water blocking layer.

### TECHNICAL FIELD

The present disclosure generally relates to dynamic submarine power cables.

### BACKGROUND

Dynamic submarine power cables are power cables designed to extend between a floating structure, such as an oil or gas platform, or a floating wind turbine, and the seabed, or to be suspended between two floating structures.

Dynamic submarine power cables are specifically manufactured to withstand fatigue damages due to the constant movement as a result of wave motion better than static submarine power cables.

In general, the life expectancy of a dynamic submarine power cable from a mechanical perspective depends on how well the cable is able to distribute the stress during movement.

### SUMMARY

It has been found by the present inventors that if the contact surfaces between the insulation system and the metallic sheath restrain movement between these components, the life expectancy of a dynamic submarine power cable will be positively influenced. This may in particular be an issue when the load is dynamic, resulting in different thermal conditions in the dynamic submarine power cable, and thus thermal expansions and contractions, which typically means floating wind application. However, high friction between the insulation system and the metallic sheath may complicate the manufacturing process where these components may need to be able to move relative to each other more freely.

In view of the above, an object of the present disclosure is to provide a method of manufacturing a dynamic submarine power cable which solves or at least mitigates the problems of the prior art.

There is hence according to a first aspect of the present disclosure provided a method of manufacturing a dynamic submarine power cable, the method comprising: a) providing an insulation system around a conductor, the insulation system comprising an inner semiconducting layer, an insulation layer arranged around the inner semiconducting layer, and an outer semiconducting layer arranged around the insulation layer, b) providing a semiconducting polymeric layer around the outer semiconducting layer, c) providing a longitudinally welded metallic radial water blocking layer around the polymeric layer, the metallic radial water blocking layer being in contact with the polymeric layer, and d) heating the metallic radial water blocking layer after step c) such that the polymeric layer melts and forms an adhesive layer that adheres to an inner surface of the metallic radial water blocking layer.

By having a bedding layer that provides high friction between the metallic water-blocking layer and the outer semiconducting layer, movement between the metallic water-blocking layer and the outer semiconducting layer may be restricted and the life expectancy of the dynamic submarine power cable is therefore increased. Further, because the polymeric layer forms the adhesive layer only when heated in step d), prior to step d) during handling of the polymeric layer and the dynamic submarine power cable up to step d) has a lower friction. This facilitates handling of the dynamic submarine power cable during manufacturing, especially as during the manufacturing process different speed between the layers may be problematic if high friction materials are used.

According to one embodiment the layer directly underlying the polymeric layer is the outer semiconducting layer.

According to one embodiment in step b) the polymeric layer is formed by extrusion, wherein step b) further comprises cooling the polymeric layer after the extrusion and prior to step c).

According to one embodiment in step b) the polymeric layer is formed by a tape that is wound around the insulation system.

According to one embodiment the tape is a laminated tape comprising a water swellable material as an inner layer and the polymer layer as an outer layer.

One embodiment comprises providing a bedding around the outer semiconducting layer, wherein in step b) the polymeric layer is arranged outside of and in direct contact with the bedding.

According to one embodiment the polymeric layer is a polymeric adhesive compound.

According to one embodiment the polymeric layer comprises a thermoplastic polyolefin.

According to one embodiment the metallic radial water blocking layer is smooth.

According to one embodiment the metallic radial water blocking layer is corrugated.

According to one embodiment the metallic radial water blocking layer comprises copper, aluminium, or stainless steel.

According to one embodiment step c) involves folding a metal sheath around the polymeric layer, and welding the metal sheath longitudinally to obtain the metallic radial water blocking layer, wherein the polymeric layer moves with a different speed in an axial direction of the dynamic submarine power cable than the metal sheath when forming the metallic radial water blocking layer.

There is according to a second aspect of the present disclosure provided a dynamic submarine power cable comprising: a conductor, an insulation system around the conductor, the insulation system comprising an inner semiconducting layer, an insulation layer arranged around the inner semiconducting layer, and an outer semiconducting layer arranged around the insulation layer, a polymeric semiconducting adhesive layer arranged around the outer semiconducting layer, and a longitudinally welded metallic radial water blocking layer arranged around the adhesive layer, wherein the adhesive layer adheres to an inner surface of the metallic radial water blocking layer.

The dynamic submarine power cable of the second aspect may be obtainable according to the method of the first aspect.

The dynamic submarine power cable may be a high voltage or a medium voltage power cable.

The dynamic submarine power cable may be an AC power cable or a DC power cable.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a cross-sectional view of an example of a dynamic submarine power cable;

FIG. 2 schematically shows a cross-sectional view of another example of a dynamic submarine power cable; and

FIG. 3 is a flowchart of a method of manufacturing a dynamic submarine power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

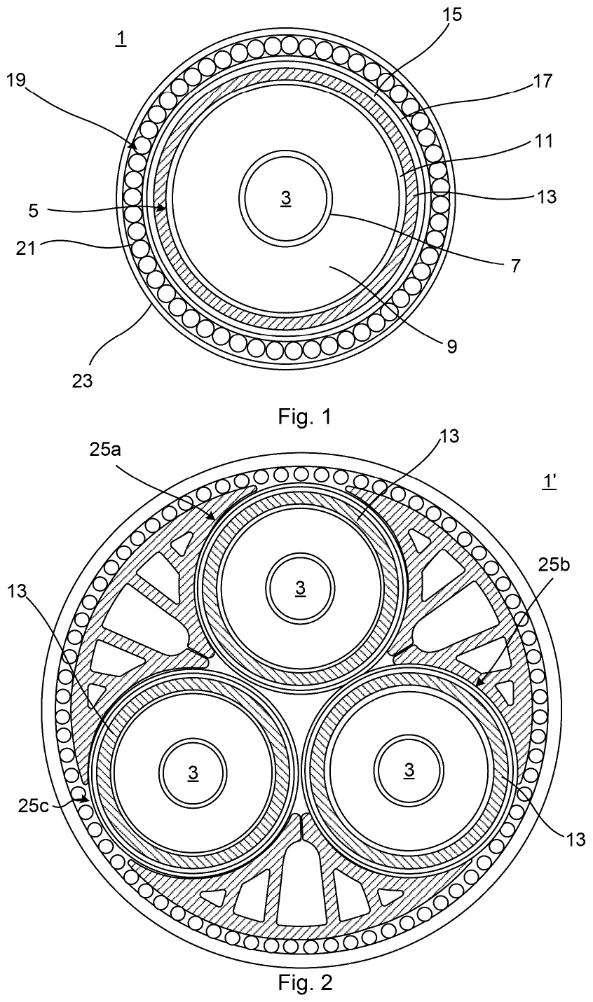

FIG. 1 shows an example of a dynamic submarine power cable 1. The dynamic submarine power cable 1 in the example in FIG. 1 is a single core cable.

The exemplified dynamic submarine power cable 1 may be a DC power cable or a single-phase AC power cable.

The dynamic submarine power cable 1 comprises a conductor 3. The conductor 3 may for example comprise copper or aluminium.

The dynamic submarine power cable 1 comprises an insulation system 5 arranged around the conductor 3.

The insulation system 5 comprises an inner semiconducting layer 7 arranged around the conductor 3, an insulation layer 9 arranged around the inner semiconducting layer 7, and an outer semiconducting layer 11 arranged around the insulation layer 9.

The insulation system 5 may be an extruded insulation system.

The insulation system 5 may comprise polymeric material. The inner semiconducting layer 7, the insulation layer 9, and the outer semiconducting layer 11 may thus have a polymer base, for example polyethylene, cross-linked polyethylene, polypropylene, EPR, or EPDM.

The inner semiconducting layer 7 and the outer semiconducting layer 11 comprises conductive particles mixed with the polymer base. The conductive particles may for example be carbon black.

The inner semiconducting layer 7 and the outer semiconducting layer 11 may or may not be crosslinked.

The dynamic submarine power cable 1 comprises an adhesive layer 13 arranged around the outer semiconducting layer 11.

The adhesive layer 13 is formed from a polymeric layer which during manufacturing of the dynamic submarine power cable 1 was melted to become the adhesive layer 13, as will be explained in more detail in the following.

The adhesive layer 13 is semiconductive. The adhesive layer 13 may comprise a polymeric adhesive compound as base polymer, such as a thermoplastic polyolefin. The adhesive layer 13 may comprise a low-density polyethylene (LDPE), for example. The base polymer may be mixed with conductive particles, for example carbon black or other suitable conductive particles to make it semiconductive.

The dynamic submarine power cable 1 comprises a metallic radial water blocking layer 15 arranged around the adhesive layer 13. The metallic radial water blocking layer 15 may for example comprise copper, such as pure copper or a copper alloy, such as a copper-nickel alloy, a stainless steel, or aluminium.

The metallic radial water blocking layer 15 may be longitudinally welded.

The metallic radial water blocking layer 15 may be corrugated or smooth.

The adhesive layer 13 is in direct contact with an inner surface of the metallic radial water blocking layer 15. The adhesive layer 13 adheres to the inner surface of the metallic radial water blocking layer 15.

The adhesive layer 13 may be in direct contact with the outer semiconductive layer 11. Alternatively, if the dynamic submarine power cable 1 comprises a bedding, for example comprising a water swellable material and/or binder tapes, arranged around the outer semiconductive layer 11, and underneath the adhesive layer 13, the adhesive layer 13 may be in direct contact with the bedding.

The bedding may be extruded onto the outer semiconductive layer 11. Alternatively, the bedding may be in the form of a tape wound around the outer semiconductive layer 11. Thus, the adhesive layer 13 may be in direct contact simultaneously with the inner surface of the metallic radial water blocking layer 15 and with either the outer semiconductive layer 11, or the bedding.

The dynamic submarine power cable 1 may comprise a further polymer layer or sheath 17 arranged around the metallic water-blocking layer 15.

Further, the dynamic submarine power cable 1 may comprise one or more armour layers 19, each comprising a plurality of helically laid armour wires 21. The armour wires may for example comprise metal such as galvanised steel, stainless steel, or copper, or a synthetic material such as a polymer material, e.g., jacketed aramid fibres, or the armour layer 19 may comprise both metal and synthetic material armour wires 21.

The dynamic submarine power cable 1 may comprise an outer sheath or serving 23 arranged around the sheath 17 and around the armour layer(s) 19, if present. The outer sheath or serving 23 may comprise a polymeric material.

FIG. 2 shows another example of a dynamic submarine power cable. The dynamic submarine power cable 1′ in FIG. 2 is a multi-core dynamic submarine power cable comprising a plurality of power cores 25a-25c. Each power core 25a-25b is very similar in structure to the dynamic submarine power cable 1 described above. Thus, each power core 25a-25c comprises a respective insulation system 5, adhesive layer 13, and metallic water blocking layer 15.

In an installed state, the dynamic submarine power cable 1, 1′ is connected to a floating structure through e.g., a bend stiffener or a Bellmouth and extends down to the seabed from the floating structure or to another floating structure.

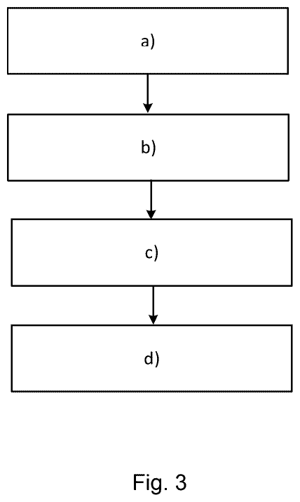

FIG. 3 is a flowchart of a method of manufacturing a dynamic submarine power cable such as the dynamic submarine power cable 1, 1′.

In a step a) the insulation system 5 is provided around the conductor 3.

In a step b) a semiconducting polymeric layer is provided around the outer semiconducting layer 11 of the insulation system 5.

The polymeric layer may be extruded onto the outer semiconductive layer 11, or it may be in the form of a tape wound around the outer semiconductive layer 11.

In case the dynamic submarine power cable 1, 1′ comprises a water swellable material, the polymeric layer may be provided around the water swellable material if the water swellable material is extruded onto the outer semiconducting layer 11 or if the water swellable material is formed by a separate tape. Alternatively, the water swellable material and the polymeric layer may form a laminated tape with the water swellable material forming an inner layer and the polymeric layer forming an outer layer of the tape.

In a step c) the metallic radial water blocking layer 15 is provided around the polymeric layer. Step c) involves folding a metal sheath around the polymeric layer, and longitudinally welding the metal sheath, thus forming the radial water blocking layer 15.

In step c) the metal sheath, and the metallic radial water blocking layer 15, which is made gradually as the metal sheath is folded around the polymeric layer and its opposing edges are welded together, may move at a different speed than the cable core structure formed by the conductor, the insulation system, and the polymeric layer, during processing in the manufacturing line.

In step c), the metallic radial water blocking layer 15 is arranged to be in contact, i.e., in direct contact, with the polymeric layer. This may for example be done by diameter reduction of the metallic radial water blocking layer 15, after it has been longitudinally welded, using rollers or a die.

In case the polymeric layer is made by extrusion, the polymeric layer may be cooled down before step c).

In a step d) the metallic radial water blocking layer 15 is heated after step c). The metallic radial water blocking layer 15 is heated to a temperature which causes the polymeric layer to melt and form the adhesive layer 13. The adhesive layer 13 thus adheres to an inner surface of the metallic radial water blocking layer 15. The adhesive layer 13 also adheres to the layer directly underneath it, e.g., the outer semiconducting layer 11 or the bedding. The adhesive layer 13 thus provides high friction and/or even grip between the metallic radial water blocking layer 15 and the layer directly underneath the adhesive layer 13. However, before the polymeric layer has been melted, the friction between the metallic radial water blocking layer 15 and the layer directly underneath the polymeric layer will be lower than when the adhesive layer 13 has been formed.

The material of which the polymeric layer is composed is selected to have a lower melting point than the outer semiconducting layer 11 but a higher melting point than the maximum allowed operating temperature of the dynamic submarine power cable 1, 1′.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of manufacturing a dynamic submarine power cable, the method comprising:
a) providing an insulation system around a conductor, the insulation system including an inner semiconducting layer, an insulation layer arranged around the inner semiconducting layer, and an outer semiconducting layer arranged around the insulation layer,
b) providing a semiconducting polymeric layer around the outer semiconducting layer,
c) providing a longitudinally welded metallic radial water blocking layer around the polymeric layer, the metallic radial water blocking layer being in contact with the polymeric layer, and
d) heating the metallic radial water blocking layer after step c) such that the polymeric layer melts and forms an adhesive layer that adheres to an inner surface of the metallic radial water blocking layer.

2. The method as claimed in claim 1, wherein the layer directly underlying the polymeric layer is the outer semiconducting layer.

3. The method as claimed in claim 1, wherein in step b) the polymeric layer is formed by extrusion, wherein step b) further comprises cooling the polymeric layer after the extrusion and prior to step c).

4. The method as claimed in claim 1, wherein in step b) the polymeric layer is formed by a tape that is wound around the insulation system.

5. The method as claimed in claim 4, wherein the tape is a laminated tape including a water swellable material as an inner layer and the polymer layer as an outer layer.

6. The method as claimed in claim 1, including providing a bedding around the outer semiconducting layer, wherein in step b) the polymeric layer is arranged outside of and in direct contact with the bedding.

7. The method as claimed in claim 1, wherein the polymeric layer is a polymeric adhesive compound.

8. The method as claimed in claim 1, wherein the polymeric layer includes a thermoplastic polyolefin.

9. The method as claimed in claim 1, wherein the metallic radial water blocking layer is smooth.

10. The method as claimed in claim 1, wherein the metallic radial water blocking layer is corrugated.

11. The method as claimed in claim 1, wherein the metallic radial water blocking layer includes copper, aluminium, or stainless steel.

12. The method as claimed in claim 1, wherein step c) involves folding a metal sheath around the polymeric layer, and welding the metal sheath longitudinally to obtain the metallic radial water blocking layer, wherein the polymeric layer moves with a different speed in an axial direction of the dynamic submarine power cable than the metal sheath when forming the metallic radial water blocking layer.

13. A dynamic submarine power cable comprising:
a conductor,
an insulation system around the conductor, the insulation system including an inner semiconducting layer, an insulation layer arranged around the inner semiconducting layer, and an outer semiconducting layer arranged around the insulation layer,
a polymeric semiconducting adhesive layer arranged around the outer semiconducting layer, and
a longitudinally welded metallic radial water blocking layer arranged around the adhesive layer, wherein the adhesive layer adheres to an inner surface of the metallic radial water blocking layer.

14. The method as claimed in claim 2, wherein in step b) the polymeric layer is formed by extrusion, wherein step b) further comprises cooling the polymeric layer after the extrusion and prior to step c).

15. The method as claimed in claim 2, wherein in step b) the polymeric layer is formed by a tape that is wound around the insulation system.

16. The method as claimed in claim 2, including providing a bedding around the outer semiconducting layer, wherein in step b) the polymeric layer is arranged outside of and in direct contact with the bedding.

17. The method as claimed in claim 2, wherein the polymeric layer is a polymeric adhesive compound.

18. The method as claimed in claim 2, wherein the polymeric layer includes a thermoplastic polyolefin.

19. The method as claimed in claim 2, wherein the metallic radial water blocking layer is smooth.

20. The method as claimed in claim 2, wherein the metallic radial water blocking layer is corrugated.
